(19) United States
(12) Patent Application Publication
(10) Pub. No.: US 2022/0402305 A1
(43) Pub. Date: Dec. 22, 2022

(54) TIRE

(71) Applicant: Sumitomo Rubber Industries, Ltd., Kobe-shi (JP)

(72) Inventors: Yuka Tsuzuki, Kobe-shi (JP); Yuichi Ishigaki, Kobe-shi (JP)

(73) Assignee: Sumitomo Rubber Industries, Ltd., Kobe-shi (JP)

(21) Appl. No.: 17/831,127

(22) Filed: Jun. 2, 2022

(30) Foreign Application Priority Data
Jun. 22, 2021 (JP) 2021-103398

(51) Int. Cl. B60C 11/00; B60C 11/12

(52) U.S. Cl. CPC B60C 11/005; B60C 11/0008; B60C 11/1204; B60C 2011/0025; B60C 2011/1213

(57) ABSTRACT

A tire includes a tread portion including a first cap rubber layer forming a ground contact surface and having a loss tangent tan δ1, and a second cap rubber layer disposed inwardly in a tire radial direction of the first cap rubber layer and having a loss tangent tan δ2, the loss tangent tan δ2 being greater than the loss tangent tan δ1. The tread portion is provided with a plurality of sipes opening to the ground contact surface, The plurality of sipes, at least partially, extends inwardly in a tire radial direction from the ground contact surface to a. location beyond a boundary between the first cap rubber layer and the second cap rubber layer, and a maximum length L2 of the plurality of sipes in the second cap rubber layer is smaller than a length L1 of the plurality of sipes at the ground contact surface.

### RELATED APPLICATIONS

This application claims the benefit of foreign priority to Japanese Patent Application No. W2021-103398, filed Jun. 22, 2021. which is incorporated by reference in its entirety.

### FIELD OF THE INVENTION

The present disclosure relates to a tire.

### BACKGROUND OF THE INVENTION

Patent Document 1 below has proposed a pneumatic tire with a tread portion including a base rubber layer having a specified loss tangent. The base rubber layer is made of low heat generation rubber that has a loss tangent smaller than that of a cap rubber layer forming the outer surface of the tread. As a result, the tire is expected to improve wear resistance and fuel efficiency.

### Patent Document

[Patent document 1] Japanese Unexamined Patent Application Publication 2017-013539

### SUMMARY OF THE INVENTION

In recent years, maintenance-free tires for a long time have been required due to consideration for the environment and the practical application of automatic vehicle driving technology. In particular, tires that can exhibit sufficient wet performance and steering stability until the end of wear of the tread portion are required.

The present disclosure has been made in view of the above circumstances and has a. major object to provide a tire capable of maintaining wet performance and steering stability even as the tread portion wears.

In one aspect of the present disclosure, a tire includes a tread portion including a first cap rubber layer forming a ground contact surface and having a loss tangent tan δ1, and a second cap rubber layer disposed inwardly in a tire radial direction of the first cap rubber layer and having a loss tangent tan δ2, the loss tangent tan δ2 being greater than the loss tangent tan δ1. The tread portion is provided with a plurality of sipes opening to the ground contact surface. The plurality of sipes extends inwardly in a tire radial direction from the ground contact surface to a location beyond a boundary between the first cap rubber layer and the second cap rubber layer. A maximum length L2 of the plurality of sipes in the second cap rubber layer is smaller than a length L1 of the plurality of sipes at the ground contact surface.

### BRIEF DESCRIPTION OF THE DRAWINGS

FIG. 1 is a meridian cross-sectional view of a tire in accordance with the present disclosure;

FIG. 2 is an enlarged cross-sectional view of a land portion of FIG. 1;

FIG. 3 is an enlarged cross-sectional view of the land portion and a sipe;

FIG. 4 is an enlarged cross-sectional view of the land portion when a second cap rubber layer is exposed;

FIG. 5 is an enlarged cross-sectional view of a land portion and a sipe in accordance with another embodiment:

FIG. 6 is a cross-sectional view of a sipe in accordance with another embodiment;

FIG. 7 is an enlarged cross-sectional view of a circumferential sipe; and

FIG. 8 is an enlarged view of a land portion and a sipe of a tire in accordance with a comparative example.

### DETAILED DESCRIPTRION OF THE INVENTION

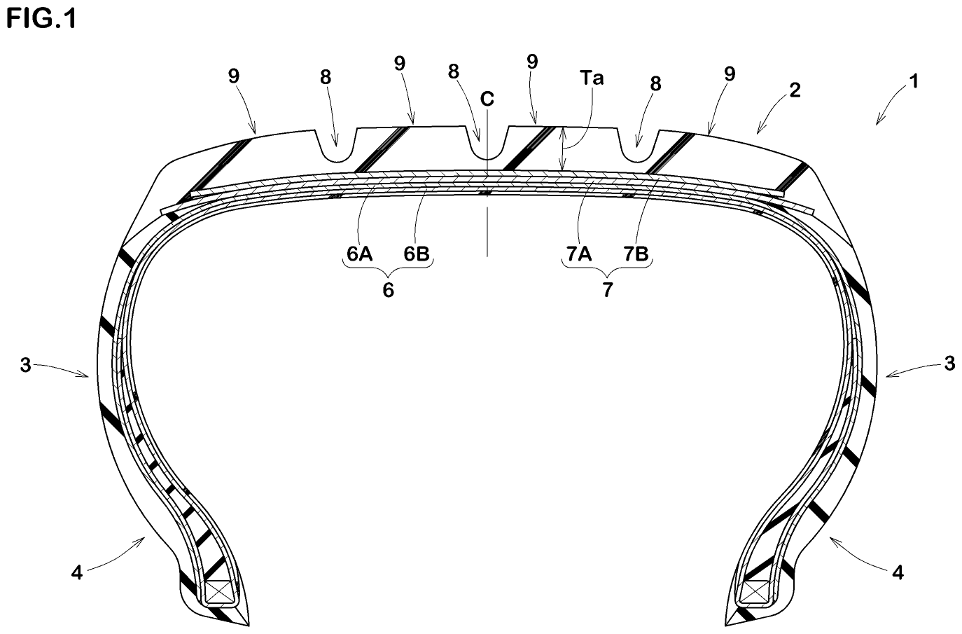

Hereinafter, one or more embodiments of the present disclosure will be described with reference to the drawings. FIG. 1 is a meridian cross-sectional view of a tire 1 in a normal state in accordance with an embodiment of the present disclosure. As illustrates in FIG. 1, the tire 1 according to the present disclosure is preferably embodied as a pneumatic tire for passenger car. However, the present disclosure is not limited to such an aspect. The present disclosure may be applied to tires for heavy-duty vehicle and motorcycle.

As used herein, when a tire is a pneumatic tire based on a standard, the “normal state” is such that the tire 1 is mounted onto a standard wheel rim with a standard pressure but loaded with no tire load. If a tire is not based on the standards, the normal state is a standard state of use according to the purpose of use of the tire and means a state of no load. As used herein, unless otherwise noted, dimensions of portions of the tire are values measured under the normal state.

As used herein, the “standard wheel rim” is a. wheel rim officially approved for each tire by standards organizations on which the tire is based, wherein the standard wheel rim is the “standard rim” specified in JAIMA, the “Design Rim” in TRA, and the “Measuring Rim” in ETRTO, for example.

As used herein, the “standard pressure” is a standard pressure officially approved for each tire by standards organizations on which the tire is based, wherein the standard pressure is the “maximum air pressure” in JAIMA, the maximum pressure given in the “Tire Load Limits at Various Cold Inflation Pressures” table in TRA, and the “Inflation Pressure” in ETRTO, for example.

The tire according to the present embodiment includes tire components therein such as a carcass 6, a belt layer 7 and the like. Known material or members are appropriately adopted for these tire components.

The carcass 6 extends between a pair of bead portions 4 through a pair of sidewall portions 3 and a tread portion 2. In the present embodiment, the carcass 6, for example, includes two carcass plies 6A and 6B. The carcass plies 6A and 6B, for example, include a plurality of organic fiber carcass cords that is oriented at an angle of from 75 to 90 degrees with respect to the tire equator C.

The belt layer 7, for example, includes two belt plies 7A and 7B. The belt plies 7A and 7B, for example, include a plurality of belt cords oriented at an angle of from 10 to 45 degrees with respect to the tire circumferential direction. For the belt cords, organic fiber cords and steel cords may be adopted as appropriate, for example. In another embodiment, a tread reinforcing layer, e.g., a band layer (not illustrated), may be disposed radially outwardly of the belt layer 7.

In the present embodiment, the tread portion 2 is provided with a plurality of circumferential grooves 8 extending continuously in the tire circumferential direction. Thus, the tread portion 2 includes a plurality of land portions 9 which is divided by the plurality of the circumferential grooves 8. Note that the present disclosure is not limited to such an aspect.

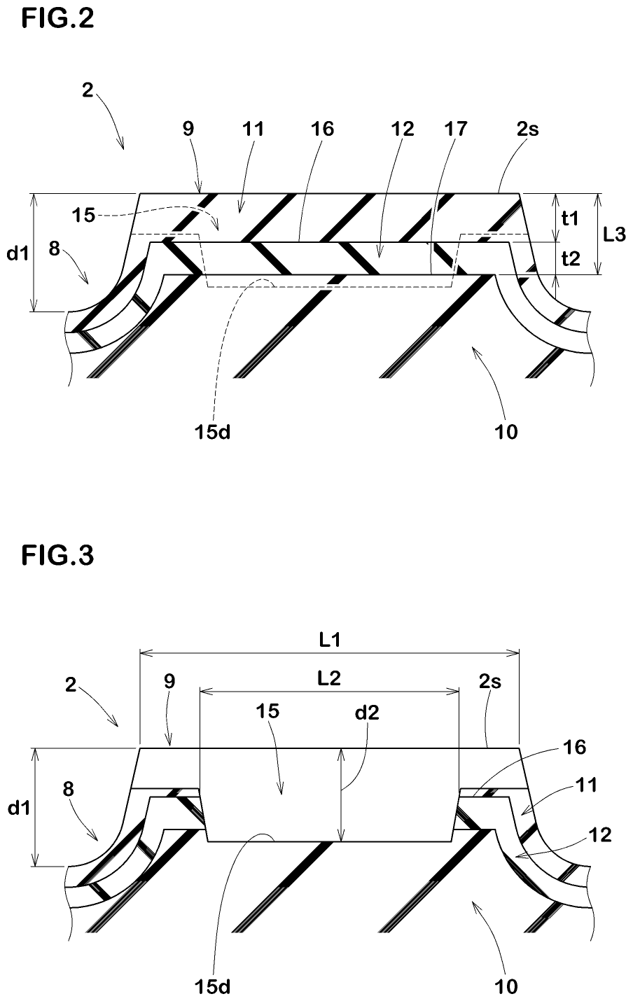

FIG. 2 illustrates an enlarged cross-sectional view of one of the land portions 9 as a figure for explaining the configuration of the tread portion 2, As illustrated in FIG, 2, the tread portion 2 includes a first cap rubber layer 11 forming a ground contact surface 2s, and a second cap rubber layer 12 disposed inwardly in the tire radial direction of the first cap rubber layer 11. In the present embodiment, the tread portion 2 further includes a base rubber layer 10 disposed inwardly in the tire radial direction of the second cap rubber layer 12. Thus, the tread portion 2 according to the present embodiment is composed of three rubber layers consisting of the first cap rubber layer 11, the second cap rubber layer 12, and the base rubber layer 10. Note that the present disclosure is not limited to such an aspect. In FIG. 2 and the subsequent figures, the rubber layers are hatched differently from each other, However, in FIG. 1, the hatching is omitted to avoid complicating the figure.

In the present disclosure, a loss tangent tan 62 of the second cap rubber layer 12 is greater than a loss tangent tan δ1 of the first cap rubber layer 11. As used herein, loss tangent tan δ is a value measured using a dynamic viscoelasticity measuring device (Iplexer series) manufactured by GABO under the following conditions in accordance with JIS-K6394.

Initial strain: 5%

Amplitude of dynamic strain: +/−1%

Frequency: 10 Hz

Deformation mode: tensile deformation

Measurement temperature: 30 degrees C.

The tread portion 2 is provided with a plurality of sipes 15 opening to the ground contact surface 2s. In the present embodiment, the plurality of sipes 15 is configured as a plurality of lateral sipes extending in the tire axial direction. Note that in the present disclosure the sipes 15 is not particularly limited to such an embodiment. Thus, the sipes 15 may include one or more circumferential sipes extending in the tire circumferential direction. Further, both lateral sipes and circumferential sipes may be provided on the tread portion 2. Since FIG. 2 is a cross section of the land portion 9 at a position not including the sipe, the bottom 15d of one of the sipes 15 is shown by a broken line in FIG. 2.

As used herein, “sipe” is an incision having a small width. The sipe has includes two opposite inner wall surfaces facing substantially parallel and a width between the two inner wall surfaces is equal to or less than 1.5 mm. Further, “substantially parallel” means that the angle between the two inner wall surfaces is equal to or less than 10 degrees, A width of a. sipe is preferably in a range from 0.5 to 1.5 mm, more preferably 0.4 to 1.0 mm. The configuration of a sipe is not particularly limited. For example, a sipe may have at least one of a pair of sipe edges having a chamfer portion. In addition, the bottom of the sipe may be connected to a flask-bottom having a width greater than 1.5 mm.

FIG. 3 illustrates an enlarged cross-sectional view of the land portion 9 at a location of one of the sipes 15. Note that the cross section of the sipe 15 shown in FIG. 3 corresponds to the cross section along a sipe length direction of the sipe 15. As illustrated in FIG. 3, each sipe 15, at least partially, extends from the ground contact surface 2s to a location beyond a boundary 16 between the first cap rubber layer 11 and the second cap rubber layer 12. Further, each sipe 15 has a maximum length L2 in the second cap rubber layer and a length L1 at the ground contact surface 2s, wherein the maximum length L2 is smaller than the length L1. The lengths L1 and L2 mean the so-called periphery lengths measured parallel to the ground contact surface 2s ofthe tread portion 2 and along the sipe length direction.

The present disclosure, by adopting the above configuration, can maintain wet performance and steering stability even if the tread portion 2 wear progresses. The following mechanism is inferred as the reason,

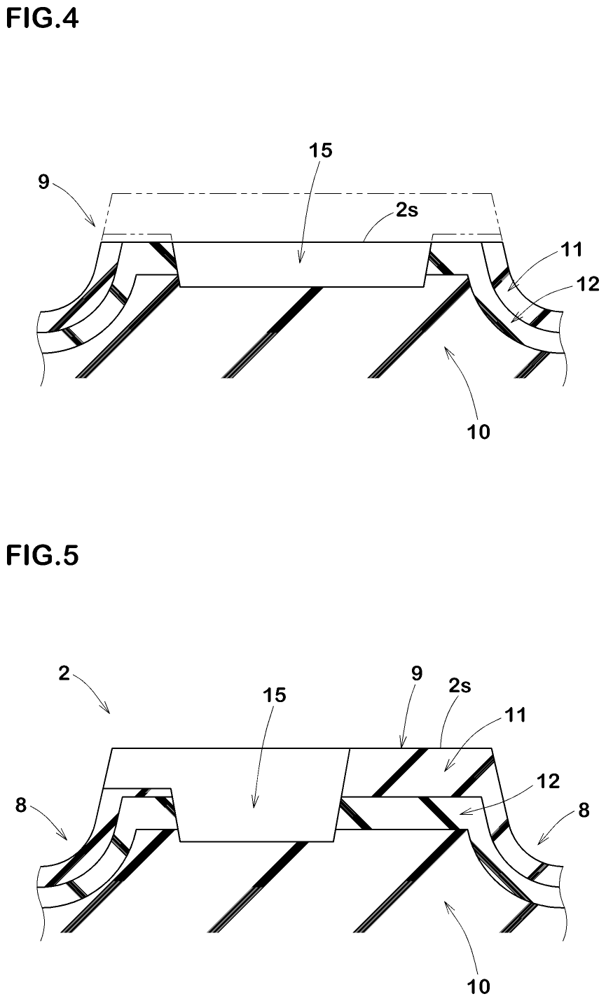

FIG. 4 illustrates an enlarged cross-sectional view of the land portion 9 when the tread portion 2 has worn down and the second cap rubber layer 12 has exposed as a ground contact surface 2s. As illustrated in FIG. 4, since the loss tangent tan δ2 of the second cap rubber layer 12 is greater than the loss tangent tan δ1 of the first cap rubber layer 11, the second cap rubber layer 12 which has been exposed at the ground contact surface 2s can exert large grip on wet roads. As a result, wet performance can be maintained.

Further, as illustrated in FIG. 3, in the present disclosure, the maximum length L2 of the sipe 15 in the second cap rubber layer 12 is smaller than the length L1 of the sipe 15 at the ground contact surface 2s. Thus, as illustrated in FIG. 4, a length of the sipe 15 when the second cap rubber layer 12 is exposed is relatively small. Therefore, even when the second cap rubber layer 12 is exposed, the rigidity of the tread portion 2 can be maintained, and the steering stability can also be maintained. Furthermore, in the present disclosure, since the rigidity of the tread portion can be maintained, the progress of wear from the state where the second cap rubber layer 12 has been exposed can be delayed.

In the present disclosure, for the above-mentioned reason, it is considered that wet performance and steering stability can be maintained even if the tread portion 2 has worn down.

Hereinafter, a more detailed configuration of the present embodiment will be described. Note that each configuration described below shows a specific aspect of the present embodiment. Thus, the present disclosure can exert the above-mentioned effects even if the tire does not include the configuration described below Further, if any one of the configurations described below is applied independently to the tire of the present disclosure having the above-mentioned characteristics, the performance improvement according. to the additional configuration can be expected. Furthermore, when some of the configurations described below are applied in combination, it is expected that the performance of the additional configurations will be improved.

As illustrated in FIG. 2, the first cap rubber layer 11, for example, has a thickness tl in a range of from 25% to 35% of a total thickness Ta (shown in FIG. 1) of the tread rubber from the ground contact surface of the tread portion 2 to an outer surface of the belt layer 7. The second cap rubber layer 12. for example, has a thickness 12 in a range of from 15% to 25% of the total thickness Ta of the tread rubber.

A distance L3 in the tire radial direction from the ground contact surface of the tread portion 2 to the boundary 17 between the second cap rubber layer 12 and the base rubber layer 10 is in a range of from 60% to 80% of the maximum depth dl of the circumferential grooves 8. Due to the arrangement of the rubber layers in this way, after the middle stage of wear of the tread portion 2, the second cap rubber layer 12, which can be expected to have a large grip force, is exposed. Thus, wet performance can be reliably maintained. in the present embodiment, the boundary 16 between the first cap rubber layer 11 and the second cap rubber layer 12, and the boundary 17 between the second cap rubber layer 12 and the base rubber layer 10 extend in parallels with the ground contact surface 2s of the tread portion 2 in the land portion.

The loss tangent tan δ1 of the first cap rubber layer 11 is preferably equal to or more than 0.13, more preferably equal to or more than 0.15, but preferably equal to or less than 0.29. more preferably equal to or less than 0.25. The loss tangent tan δ2 of the second cap rubber layer 12 is preferably equal to or more than 0.30, more preferably equal to or more than 0.33, but preferably equal to or less than 0.40, more preferably equal to or less than 0.37. Further, the loss tangent tan δ1 is preferably in a range of from 50% to 65% of the loss tangent tan δ2. Such a first cap rubber layer 11 and a second cap rubber layer 12 can improve the overall performance of the tire in a well-balanced manner, and can suppress the peeling of rubber at the boundary 16 between the first cap rubber layer 11 and the second cap rubber layer 12.

Preferably, the loss tangent tan δ1 of the base rubber layer 10 is smaller than the loss tangent tan δ1 of the first cap rubber layer 11. Specifically, the loss tangent tan δb, for example, is equal to or less than 0.12, preferably in a range of from 0,07 to 0.12. This can suppress excessive heat generation in the tread portion 2 and improve tire durability. However, the loss tangent tan δb of the base rubber layer 10 is not limited to this range.

The values of the loss tangent of the above rubber layers can be obtained by appropriately combining known materials, and the detailed description thereof is omitted herein.

As illustrated in FIG. 3, each sipe 15 according to the present embodiment is configured as a lateral sipe extending in the tire axial direction, preferably extending in parallel with the tire axial direction. Further, each sipe 15 traverses the ground contact surface of the land portion completely in the tire axial direction. As illustrated in FIG. 4, each sipe 15 according to the present embodiment has both ends terminating within the land portion 9 when the second cap rubber layer 12 has exposed as a ground contact surface. Thus, the rigidity of the tread portion 2 can reliably be maintained with the second cap rubber layer 12 exposed.

As illustrated in FIG. 3, the length L2 of each sipe 15 in the second cap rubber layer 12 is equal to or more than 60% of the length L1 of the sipe on the ground contact surface 2s, more preferably equal to or more than 65%, but preferably equal to or less than 80%, more preferably equal to or less than 75%. Such a sipe 15 can help to balance wet performance and steering stability when the tread portion 2 has worn down.

The bottom 15d of each sipe 15, for example, is located in the base rubber layer 10. Note that the bottom 15d of each sipe 15 may be located in the second cap rubber layer 12. The maximum depth d2 of each sipe 15, for example, is preferably in a range of from 75% to 100% of the maximum depth d1 of the circumferential grooves 8. Such a sipe 15 can help to improve wet performance.

The shape of the cross section of each Sipe 15 along the sipe length direction is not limited to the above-mentioned embodiment. FIG. 5 illustrates another embodiment of the sipes 15. As illustrated in FIG 5, in this embodiment, the sipe 15, on the ground contact surface 2s of the land portion 9, has one end communicated with one of the circumferential grooves 8 and the other end terminating within the land portion 9. Further, in this embodiment, when the second cap rubber layer 12 has exposed, the both ends of the sipe 15 terminate within the land portion. Such a sipe 15 can help to offer excellent steering stability.

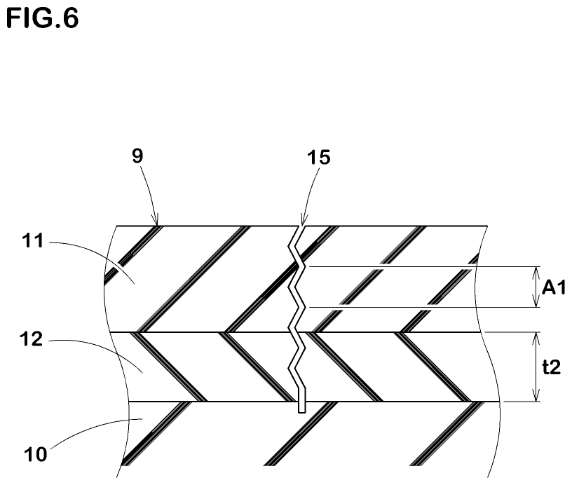

FIG. 6 illustrates a cross-sectional view of a sipe 15 in accordance with another embodiment. Note that FIG. 6 shows a cross section of the sipe 15 orthogonal to the sipe length direction. As illustrated in FIG. 6, in the cross-sectional view of the sipe 15, the sipe 15 extends in a wavy manner in the tire radial direction. Such a sipe 15 can increase the rigidity of the land portion 9 since the pair of sipe inner walls comes into contact with each other to engage, and can exhibit excellent steering stability. Needless to say, the above-mentioned configuration shown in FIG. 3 and the like can he applied as the configuration of the cross section of the sipe 15 shown in FIG. 6 along the sipe length direction.

In FIG. 6, a wave length Al in the tire radial direction of the sipe 15 is preferably in a range of from 20% to 60% of the thickness t2 of the second cap rubber layer 12. This can surely enhance the above-mentioned effect.

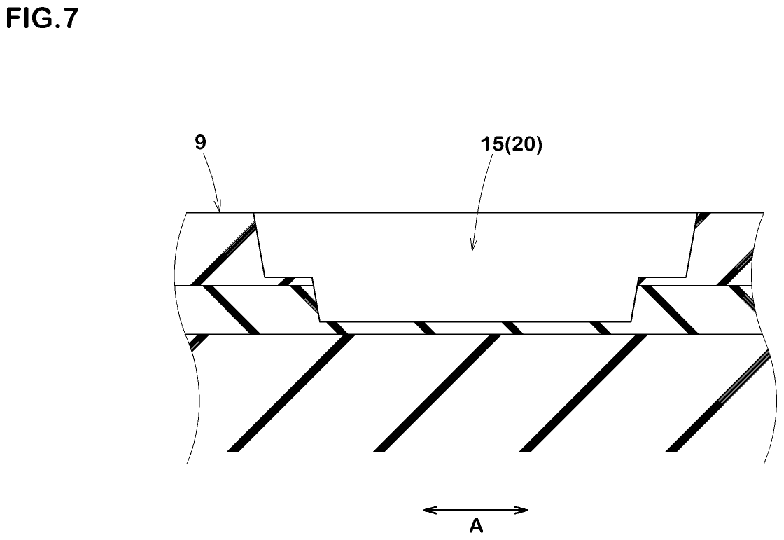

FIG. 7 illustrates an enlarged cross-sectional view of a circumferential sipe 20 in accordance with another embodiment. In FIG. 7, note that the arrow A corresponds to the tire circumferential direction. As illustrated in FIG. 7, one of the sipes 15 according to the present disclosure may be configured as a circumferential sipe 20 extending in the tire circumferential direction. In this case, the circumferential sipe 20 can provide frictional force in the tire axial direction and can improve cornering performance on wet roads.

While the particularly preferable embodiments of the tire in accordance with the present disclosure have been described in detail, the present disclosure is not limited to the illustrated embodiments, but can be modified and carried out in various aspects within the scope of the disclosure.

### EXAMPLE

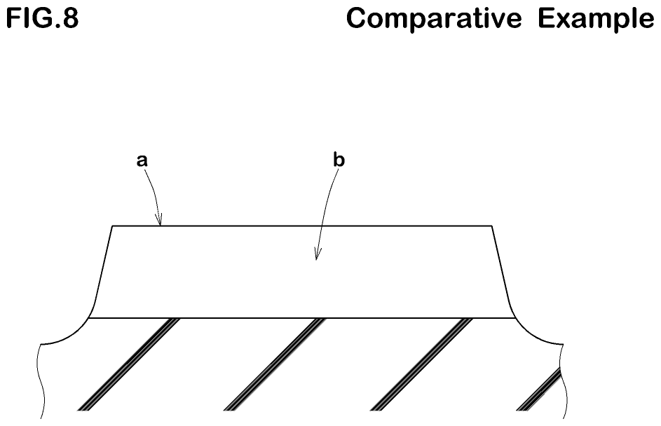

As tires according to the present disclosure, pneumatic tires of size 235/65R16C were prepared (Examples). These tires have the basic structure shown in FIG. 1. Further, these tires have tread rubber layers shown in FIG. 2 where a plurality of sipes shown in FIG. 3 are formed, As a comparative example, a tire having land portion (a) with sipes h shown in FIG. 8 was also prepared. The comparative tire has a loss tangent tan δ1 of the first cap rubber layer which is greater than a loss tangent tan δ2 of the second cap rubber layer. The sipes b of the comparative example traverse the land portion (a) completely in the tire axial direction. The comparative tire is substantially the same as the tires of the examples except for the above-mentioned features. Then, wet performance and steering stability of these test tires were tested for each of the new and 50% worn conditions, The 50% worn condition is a condition in which the depths of the circumferential grooves have worn down until 50% depth. The common specifications and test methods for each test tire are as follows.
Rim size: 16×7.0J
Tire inner pressure: 475 kPa lest vehicle: displacement 3000 cc, rear-wheel drive
Test tire location: all wheels

Wet performance test (new and 50% worn conditions):

The wet performance when driving on a wet road surface with the test vehicle equipped with test tires was evaluated by the driver's sensuality. The test results are indicated in Tables 1 and 2 using a score with the wet performance of the comparative example as a new product as 100, and the larger the value, the better the wet performance.

### Steering Stability Test (New and 50% Worn Conditions):

The steering stability when driving on a dry road surface with the test vehicle equipped with test tires was evaluated by the driver's sensuality. The test results are indicated in Tables 1 and 2 using a score with the steering stability of the comparative example as a new product as 100, and the larger the value, the better the steering stability.

Tables 1 and 2 show the test results.

TABLE 1

| | Ref. | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Land portion and sipe configuration | FIG. 8 | FIG. 3 | FIG. 3 | FIG. 3 | FIG. 3 | FIG. 3 | FIG. 3 | FIG. 3 | FIG. 3 |
| Loss tangent tan δ1 of first cap rubber layer | 0.35 | 0.20 | 0.13 | 0.15 | 0.25 | 0.29 | 0.20 | 0.20 | 0.20 |
| Loss tangent tan δ2 of second cap rubber layer | 0.20 | 0.35 | 0.35 | 0.35 | 0.35 | 0.35 | 0.30 | 0.33 | 0.37 |
| Sipe length L2 in second cap rubber layer/sipe | — | 70 | 70 | 70 | 70 | 70 | 70 | 70 | 70 |
| length L1 at ground contact surface (%) | | | | | | | | | |
| Wet performance under new condition | 100 | 95 | 93 | 95 | 97 | 99 | 94 | 95 | 95 |
| (score) | | | | | | | | | |
| Steering stability under new condition | 100 | 98 | 97 | 98 | 99 | 100 | 98 | 98 | 98 |
| (score) | | | | | | | | | |
| Wet performance under 50% worn condition | 60 | 80 | 80 | 80 | 80 | 80 | 77 | 79 | 83 |
| (score) | | | | | | | | | |
| Steering stability under 50% worn condition | 80 | 90 | 90 | 90 | 90 | 90 | 88 | 90 | 91 |
| (score) | | | | | | | | | |

TABLE 2

| | Ex. 9 | Ex. 10 | Ex. 11 | Ex. 12 | Ex. 13 |
|---|---|---|---|---|---|
| Land portion and sipe configuration | FIG. 3 | FIG. 3 | FIG. 3 | FIG. 3 | FIG. 3 |
| Loss tangent tan δ1 of first cap rubber layer | 0.20 | 0.20 | 0.20 | 0.20 | 0.20 |
| Loss tangent tan δ2 of second cap rubber layer | 0.40 | 0.35 | 0.35 | 0.35 | 0.35 |
| Sipe length L2 in second cap rubber layer/sipe | 70 | 60 | 65 | 75 | 80 |
| length L1 at ground contact surface (%) | | | | | |
| Wet performance under new condition (score) | 96 | 94 | 95 | 96 | 97 |
| Steering stability under new condition (score) | 98 | 97 | 98 | 98 | 99 |
| Wet performance under 50% worn condition (score) | 85 | 76 | 78 | 84 | 87 |
| Steering stability under 50% worn condition (score) | 92 | 91 | 90 | 89 | 87 |

As shown in Tables 1 and 2, in the comparative example, the wet performance was 60 points and the steering stability was 80 points in the 50% worn condition. On the other hand, the tires of the examples maintained a high wet performance of 77 to 85 points in the 50% worn condition. In addition, the tires of the examples maintained a high steering stability of 87 to 92 points in the 50% worn condition. As described above, it was confirmed that the tires of the examples can maintain wet performance and steering stability even when the tread portion was worn.

### [Additional Notes]

The present disclosure includes the following aspects.

### [Note 1]

A tire comprising:

a tread portion comprising
a first cap rubber layer forming a ground contact surface and having a loss tangent tan δ1, and
a second cap rubber layer disposed inwardly in a tire radial direction of the first cap rubber layer and having a loss tangent tan δ2, the loss tangent tan δ2. being greater than the loss tangent tan δ1, wherein

the tread portion is provided with a plurality of sipes opening to the ground contact surface,

the plurality of sipes, at least partially, extends inwardly in a tire radial direction from the ground contact surface to a location beyond a boundary between the first cap rubber layer and the second cap rubber layer, and

a maximum length L2 of the plurality of sipes in the second cap rubber layer is smaller than a length L1 of the plurality of sipes at the ground contact surface.

### [Note 2]

The tire according to note 1, wherein

the loss tangent tan δ1 is in a range from 0.13 to 0.29.

### [Note 3]

The tire according to note 1 or 2, wherein

the loss tangent tan δ2 is in a range from 0.30 to 0.40.

### [Note 4]

The tire according to any one of notes 1 to 3, the tread portion further comprising a base rubber layer disposed inwardly in the tire radial direction of the second cap rubber layer, wherein

the base rubber layer has a loss tangent tan δb smaller than the loss tangent tan δ1

### [Note 5]

The tire according to note 4, wherein

the loss tangent tan δb is equal to or less than 0.12.

### [Note 6]

The tire according to any one of notes 1 to 5, wherein

the tread portion is provided with a plurality of circumferential grooves extending continuously in a tire circumferential direction, and

a maximum depth of the plurality of sipes is in a range from 75% to 100% of a maximum depth of the plurality of circumferential grooves.

### [Note 7]

The tire according to any one of notes 1 to 6, wherein

the maximum length L2 of the plurality of sipes in the second cap rubber layer is in a range from 60% to 80% of the length L1 of the plurality of sipes at the ground contact surface.

### [Note 8]

The tire according to any one of notes 1 to 7, wherein

in a cross-sectional view of each of the plurality of sipes the plurality of sipes extends in a wavy manner in the tire radial direction.

### [Note 9]

The tire according to note 8, wherein

each of the plurality of sipes has a wavelength in a range from 20% to 60% of a thickness in the tire radial direction of the second cap rubber layer.

### [Note 10]

The tire according to any one of notes 1 to 9, wherein the plurality of sipes comprises one or more lateral sipes extending in a tire axial direction.

### [Note 11]

The tire according to any one of notes 1 to 10, wherein the plurality of sipes comprises one or more circumferential sipes extending in a tire circumferential direction.

1. A tire comprising:
a tread portion comprising
a first cap rubber layer forming a ground contact surface and having a loss tangent tan δ1, and
a second cap rubber layer disposed inwardly in a tire radial direction of the first cap rubber layer and having a loss tangent tan δ2, the loss tangent tan δ2 being greater than the loss tangent tan δ1, wherein
the tread portion is provided with a plurality of sipes opening to the ground contact surface,
the plurality of sipes, at least partially, extends inwardly in the tire radial direction from the ground contact surface to a location beyond a boundary between the first cap rubber layer and the second cap rubber layer, and
a maximum length L2 of the plurality of sipes in the second cap rubber layer is smaller than a length L1 of the plurality of sipes at the ground contact surface.

2. The tire according to claim 1, wherein
the loss tangent tan δ1 is in a range from 0.13 to 0.29.

3. The tire according to claim 1, wherein
the loss tangent tan δ2 is in a range from 0.30 to 0.40.

4. The tire according to claim 1, the tread portion further comprising a base rubber layer disposed inwardly in the tire radial direction of the second cap rubber layer, wherein
the base rubber layer has a loss tangent tan δb smaller than the loss tangent tan δ1.

5. The tire according to claim 4, wherein
the loss tangent tan δb is equal to or less than 0.12.

6. The tire according to claim 1. wherein
the tread portion is provided with a plurality of circumferential Trooves extending continuously in a tire circumferential direction, and
a maximum depth of the plurality of sipes is in a range from 7.5% to 100% of a maximum depth of the plurality of circumferential grooves.

7. The tire according to claim 1, wherein
the maximum length L2 of the plurality of sipes in the second cap rubber layer is in a range from 60% to 80% of the length L1 of the plurality of sipes at the ground contact surface.

8. The tire according to claim 1, wherein
in a cross-sectional view of each of the plurality of sipes the plurality of sipes extends in a wavy manner in the tire radial direction.

9. The tire according to claim 8, wherein
each of the plurality of sipes has a wavelength in a range from 20% to 60% of a thickness in the tire radial direction of the second cap rubber layer.

10. The tire according to claim 1, wherein
the plurality of sipes comprises one or more lateral sipes extending in a tire axial direction.

11. The tire according to claim 1, wherein
the plurality of sipes comprises one or more circumferential sipes extending in a tire circumferential direction.

12. The tire according to claim 1. wherein
the loss tangent tan δ1 is in a range from 0.13 to 0.29, and the loss tangent tan δ2 is in a range from 0.30 to 0.40.

13. The tire according to claim 5, wherein
the loss tangent tan δ1 is in a range from 0.13 to 0.29, and the loss tangent tan δ2 is in a range from 0.30 to 0.40.

14. The tire according to claim 12. wherein
the first cap rubber layer is direct contact with the second cap rubber layer.

15. The tire according to claim 13, wherein
the base rubber layer is direct contact with the second cap rubber layer.

16. The tire according to claim 4, wherein
the plurality of sipes comprises a sipe having a bottom, and
a middle part in a sipe length direction of the bottom extends in the base rubber in parallel with the ground contact surface.

17. The tire according to claim 16, wherein
at least one end part in the sipe length direction of the bottom extends in the first cap rubber layer in parallel with the ground contact surface.

18. The tire according to claim 17, wherein
a length in the sipe length direction of the at least one end part is smaller than that of the middle part.

19. The tire according to claim 17, wherein
the tread portion comprises a land portion being provided with the plurality of sipes, and the sipe traverses the land portion completely in a tire axial direction.

20. The tire according to claim 17, wherein
the tread portion comprises a land portion being provided with the plurality of sipes, and the sipe comprises one end terminating within the land portion.
